(19) United States
(12) Patent Application Publication
(10) Pub. No.: US 2008/0199658 A1
(43) Pub. Date: Aug. 21, 2008

(54) Leather Made Of Tuna Skin And The Manufacturing Method Thereof

(76) Inventors: Yo-Chan Kim, Seoul (KR); Chang-Yeol Yoon, Gyeonggi-do (KR)

Correspondence Address: HARNESS, DICKEY, & PIERCE, P.L.C, 7700 Bonhomme, Suite 400, ST. LOUIS, MO, 63105, US

(21) Appl. No.: 11/917,123

(22) PCT Filed: Apr. 28, 2006
(86) PCT No.: PCT/KR2006/001621

§ 371 Date: Dec. 10, 2007

(30) Foreign Application Priority Data
Jun. 14, 2005 (KR) 10-2005-0051083

(51) Int. Cl. C14C 1/08; C14C 13/00

(52) U.S. Cl. 428/151; 8/94.12

(57) ABSTRACT

It is an object of the present invention to provide leather made of tuna skins as a novel material that is distinguished from existing leather material. To achieve such an object, the present invention is characterized in that tuna skins which have been utilized only for general byproducts of tuna is used as a material for leather. The tuna skin leather manufactured in this way has moire patterns unique to tunas created through the splitting process, which in turn provide beauty totally different from that of general leather. In addition, the tuna skin leather is superior in tensile strength and venting property comparing with conventional general leather, thereby making it possible to satisfy the desires of consumers who long for new materials, and to contribute the expansion of leather markets.

### TECHNICAL FIELD

The present invention generally relates to leather made from tuna skin, and more particularly to tuna skin leather processed as leather by combining the tuna skin with manufacturing technology of general leather.

### BACKGROUND ART

Currently, skins of a wide variety of animals are used as raw materials for natural leather. For example, hides of mammals such as cows, horses, pigs, sheep, lambs and antelopes are known as materials for leather. In addition, skins of birds such as ostriches, and skins of reptiles such as alligators, crocodiles, lizards and snakes are also used as materials for natural leather. Furthermore, marine or freshwater fishes such as eels, rays, and sharks are also utilized as raw materials for leather.

### DISCLOSURE

### Technical Problem

However, there exists much difference in texture, pattern, and usage depending upon what kinds of hides or skins are used for natural leather. Therefore, it is continuously required to research on novel materials for leather in order to satisfy the tastes of various consumers.

### Technical Solution

Accordingly, present inventors have performed researches to discover new materials distinguished from conventional leather for a long time. Consequently, the inventors have found out not only that the leather has excellent durability when manufactured from tuna skins, but also that it is possible to differentiate the leather of tuna skins from existing leather materials in its design owing to the patterns of unique fiber structure as well as delicate color tones of tuna skins, thereby making it possible to use the leather of tuna skins in various ways and resulting in the present invention.

Tuna skins have both characteristics of leather and fiber since the tuna skins are formed of four-layer structure including the grain (skin surface) and each layer is composed of lattice structures therebetween. Owing to such structural characteristics, the tuna skin leather is superior in durability such as tensile strength, and it is possible to create a moiré structure through a splitting process.

### ADVANTAGEOUS EFFECTS

The tuna skin leather in accordance with the invention has natural moiré patterns unique to tuna skins which can not be seen in any other existing leather. In particular, every product has different moiré patterns like human fingerprints; accordingly it is possible to satisfy the desires of consumers who long for unique and variously distinguished designs.

### DESCRIPTION OF THE DRAWINGS

These and other features, aspects, and advantages of the present invention will be described with reference to the accompanying drawings, in which like components are referred to by like reference numerals. In the drawings:

FIGS. 1 and 2 are photographs of tuna skin leather with moiré patterns created in accordance with an embodiment of the present invention;

FIG. 3 is a photograph of wallets manufactured with the above tuna skin leather;

FIG. 4 is a photograph of tuna skin leather with scale patterns unique to tuna skin;

FIG. 5 is a photograph of purses and wallets manufactured with the tuna skin leather having moiré patterns that has been created through a re-dyeing process in accordance with another embodiment of the present invention;

FIG. 6 shows test results of the tuna skin leather in accordance with an embodiment of the present invention;

FIG. 7 shows test results of conventional cowhide leather and sheepskin leather.

### BEST MODE

Hereinafter, the constitution and the effects of the present invention will be described in detail with reference to the embodiments and exemplary tests. The following embodiments are intended only for the purpose of illustrating the invention, and those of ordinary skill in the art will appreciate clearly that the embodiments will not limit the scope and spirit of appended claims of the present invention. That is, numerous changes and modifications to such embodiments of the present invention will be made readily by those skilled in the art, and such changes and modifications are intended to be included within the scope of the invention.

### Embodiment 1

Tuna skins were acquired from their habitats such as oceans around Southeast Asian countries, transported by a refrigerator ship, and were subjected to the processes below.

### (1) Soaking

The tuna skins transported in frozen state were soaked for about 2 hours in a solution of 27° C. prepared by mixing water, NaSH, and surfactant (product name “WIN92”, manufactured by “Enbio Tech”) containing 8% or more of methyl alcohol component, in the ratio of 300:0.2:0.2 respectively on the basis of mass, and were dehydrated. Thereafter, the tuna skins were soaked for about 3 hours in a solution of 27° C. prepared by mixing water, bactericide, WIN92, sodium chloride, and soda ash in the ratio of 300:0.1:0.2:10.0:0.5 respectively on the basis of mass, and were dehydrated.

### (2) Liming

The tuna skins that had been were dehydrated through the process (1) were soaked for an hour in a solution of 27° C. prepared by mixing water, lime, surfactant of amine series (product name “KG-54”, manufactured by “Enbio Tech”), Na₂S, WIN92 in the ratio of 300:8.0:3.0:8.0:0.2 respectively on the basis of mass. Then the solution having tuna skins therein was disturbed for 5 minutes, and then was left as it was for 115 minutes. Such alternate processes were performed repeatedly in a controlled manner until the next morning. Thereafter, the tuna skins were washed out thoroughly with water, and were soaked for 10 minutes in a solution of 24° C. prepared by mixing water, lime, KG-54 in the ratio of 300:3.0:1.0 respectively on the basis of mass. Then, the solution having tuna skins therein was disturbed for 5 minutes, and then was left as it was for 115 minutes. Such alternate processes were repeated, and then the tuna skins were washed out with water.

### (3) Deliming

The tuna skins that had been subjected to the process (2) were soaked for 30 minutes in a solution of 32° C. prepared by mixing water, and ammonium sulfate ((NH₄)₂SO₄) in the ratio of 200:0.5 respectively on the basis of mass, and were dehydrated. Thereafter, the tuna skins were soaked for 3 hours in a solution of 32° C. prepared by mixing water, sal ammoniac ((NH₄)Cl), ammonium sulfate, and WIN92 in the ratio of 200:4.0:2.0:1.0 respectively on the basis of mass.

### (4) Bating

The pH value of the solution in which the tuna skins were being soaked was adjusted to 8.5, and into which a protein breakdown enzyme (product name “POLYZIM 700”, manufactured by “Enbio Tech”) of 700 of titer in the ratio of 2.5 with respect to 200 of water on the basis of mass was added. Then the tuna skins were left as they were for 3 hours, followed by being washed out with water.

### (5) Pickling

The tuna skins that had been subjected to the process (4) were soaked for 3 hours in a solution of 32° C. prepared by mixing water and WIN92 in the ratio of 300:3.0 respectively on the basis of mass and were dehydrated. Then, the tuna skins were soaked for 5 hours in a solution of 32° C. prepared by mixing water and WIN92 in the ratio of 300:1.0 respectively on the basis of mass, and were washed out thoroughly. Next, the tuna skins were soaked for 20 minutes in a solution of 22° C. prepared by mixing water and sodium chloride, and then formic acid (HCOOH) in the ratio of 1.0 with respect to 150 of water on the basis of mass was added to the solution. Thereafter, the solution having the tuna skins therein was left as it was. Sulfuric acid (H₂SO₄) in the ratio of 1.3 with respect to 150 of water on the basis of mass was further added to the solution, and then the tuna skins were left as they were.

### (6) Tanning

Chrome (33% of Cr₂O₃) in the ratio of 3.0 with respect to 150 of water on the basis of mass was added to the solution in which the tuna skins were being soaked, and the solution having tuna skins therein was left as it was for 60 minutes. Next, chrome in the ratio of 4.0 with respect to 150 of water on the basis of mass was further added to the solution, and the solution having tuna skins therein was left as it was for 90 minutes. Thereafter, sodium bicarbonate (NaHCO₃) in the ratio of 0.7 with respect to 150 of water on the basis of mass was added to the solution, and the solution having the tuna skins therein was disturbed for 10 minutes and was left as it was for 50 minutes. Again, sodium bicarbonate in the ratio of 0.7 with respect to 150 of water on the basis of mass was added to the solution, and the solution was disturbed for 10 minutes and was left as it was for 50 minutes. Such alternate processes were repeated eight times. While repeating such processes, sodium bicarbonate was added to make the pH value of the solution be 4.2, and the temperature of the solution was made to become 43° C. After dehydration, the tuna skins were matured for 24 hours.

### (7) Dyeing

The tuna skins matured by the process (6) described above were soaked for 40 minutes in a solution of 40° C. prepared by mixing water and WIN92 in the ratio of 150:0.2 respectively on the basis of mass and were dehydrated. Then, the tuna skins were soaked for an hour in a solution of 40° C. prepared by mixing water, chrome, tanning oil (product name “BZU”, manufactured by “Texapel” of France), and sodium formate in the ratio of 150:3.0:3.0:1.0 on the basis of mass and were dehydrated. Next, the tuna skins were left for an hour in a solution of 40° C. prepared by mixing water, sodium formate, and sodium bicarbonate (NaHCO₃) in the ratio of 150:2.0:2.5 on the basis of mass, and hot water of 70° C. and synthetic oil (product name “OIL 505”, manufactured by “Goryo Industry”) in the ratio of 150:100 respectively on the basis of mass were added into the solution and the solution was left as it was for an hour. OIL 505 in the ratio of 14 with respect to 150 of water on the basis of mass was added to the solution, and the solution having the tuna skins therein was left as it was for 90 minutes. Thereafter, formate in the ratio of 1.0 with respect to 150 of water on the basis of mass was further added to the solution to make the pH value of the solution be 4.2 and the solution having the tuna skins therein was left as it was for 30 minutes. Then, the tuna skins were dehydrated. After dehydration, the tuna skins were put in a solution prepared by mixing cold water of 20° C. or low with a specified dye and were left as they were for 30 minutes. Subsequently, hot water of 70° C. and formate in the ratio of 100:1.8 respectively on the basis of mass were added to the solution, and the solution having the tuna skins therein was left as it was. Thereafter, the tuna skins were washed out thoroughly and dehydrated.

### (8) Drying

The tuna skins that had been subjected to the processes described above were put in a dryer to dehumidify them.

### (9) Splitting

The tuna skins that had been subjected to the processes described above were split to produce moiré patterns unique to the tuna skins.

### (10) Finishing

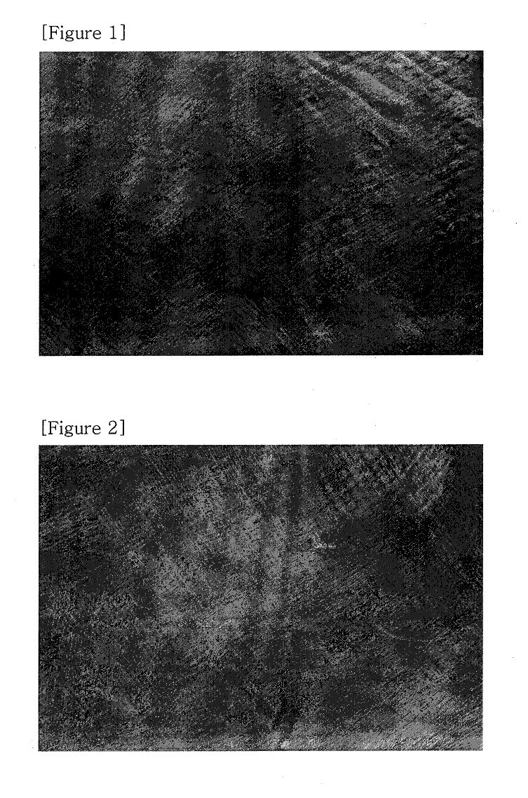

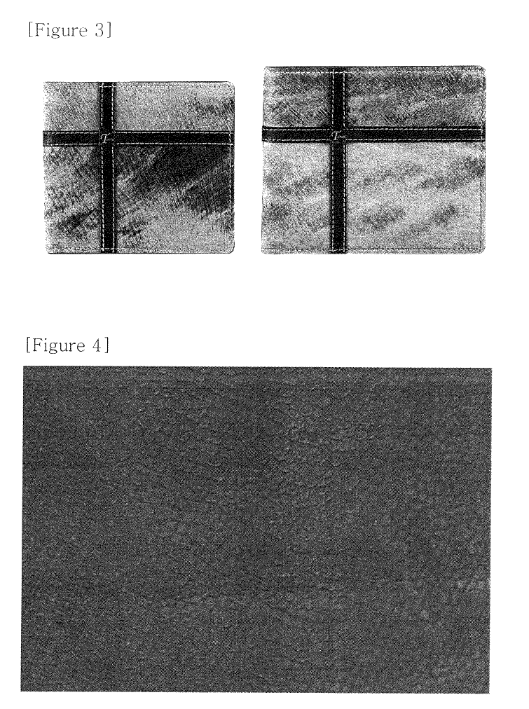

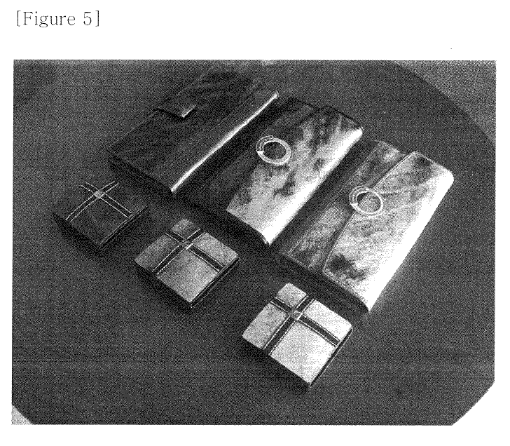

Finally, tuna skin leather with moiré patterns was completed through general finishing process (see FIGS. 1 and 2). In addition, wallets were made as trial products with the use of such leather that had been subjected to the processes described above (see FIG. 3). For reference, the side with scales was manufactured as leather having scale pattern unique to tuna skins created thereon, as shown in FIG. 4.

### Embodiment 2

In this embodiment, tuna skin leather was manufactured in the same procedure as the embodiment 1, except that the tuna skins were further subjected to re-dyeing process after the splitting process. Specifically, desired dyes were sprayed onto the split side having moiré patterns created thereon after splitting process, and then the split side was left as it was to dry. The dyes used may include aqueous dyes and oily dyes; however, an oily dye prepared by mixing dye and thinner in the ratio of 1:1 was used in the present invention. After re-dyeing process, tuna skin leather was completed through general finishing process. Several kinds of purses and wallets were manufactured as trial products with the use of such leather (see FIG. 5).

### Exemplary Tests

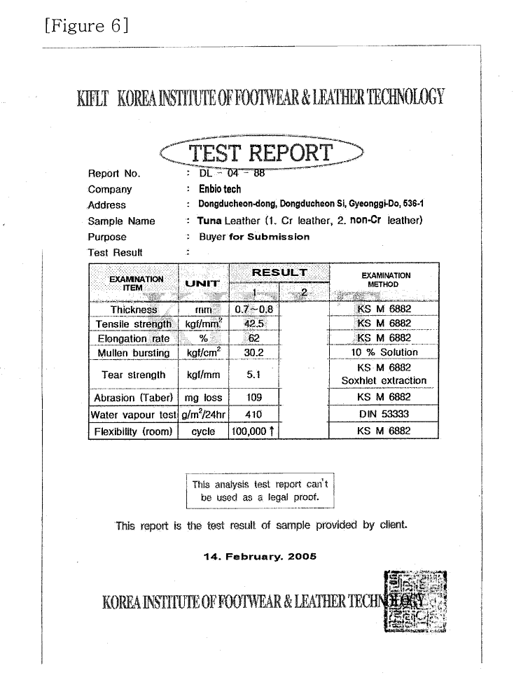

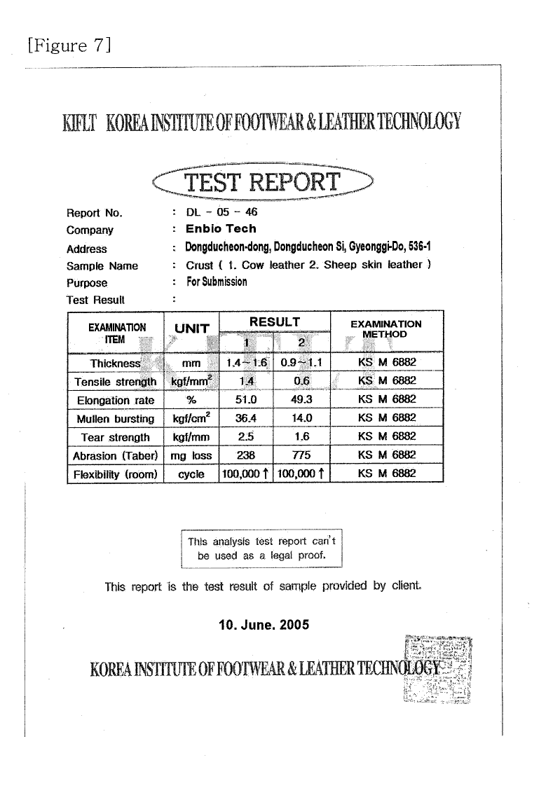

Tests on the thickness, tensile strength, elongation rate, Mullen bursting, tear strength and abrasion were carried out by Korea Institute of Footwear & Leather Technology (KIFLT), in order to compare and evaluate the qualities between the tuna skin leather manufactured in accordance with the embodiments described above and general cowhide leather and sheepskin leather. The results are shown in Table 1 as follows (see FIGS. 6 and 7):

TABLE 1

| | | | Sheepskin |
|---|---|---|---|
| Test Category | Tuna Skin Leather | Cowhide Leather | Leather |
| Thickness (mm) | 0.7~0.8 | 1.4~1.6 | 0.9~1.1 |
| Tensile Strength | 42.5 | 1.4 | 0.6 |
| (kgf/mm²) | | | |
| Elongation rate (%) | 62 | 51.0 | 49.3 |
| Mullen Bursting | 30.2 | 36.4 | 14.0 |
| (kgf/cm²) | | | |
| Tear Strength | 5.1 | 2.5 | 1.6 |
| (kgf/mm) | | | |
| Abrasion (mg loss) | 109 | 238 | 775 |

As can be seen from the above Table 1, though the tuna skin leather in accordance with the present invention is thinner than conventional cowhide leather and sheepskin leather, the tuna skin leather has higher tensile strength by over 30 times than conventional cowhide and sheepskin leather and is superior in tear strength and abrasion by over two times to conventional cowhide and sheepskin leather. In other words, it can be seen that the tuna skin leather in accordance with the present invention exhibits characteristics such as hardness and toughness to external impact.

### MODE FOR INVENTION

Hereinafter, a method of manufacturing tuna skin leather of the present invention will be described in detail by each step. However, the same description as that of process of manufacturing general leather will not be made in detail.

### (1) Soaking

This process is for restoring the protein tissue of original raw skin state to make the tuna skin flexible, and for removing impurities such as filth, salt contents, and water-soluble protein on the surface of the tuna skin to halt the activity of viruses, by soaking the tuna skin into water.

Unlike in the process of manufacturing general leather, it is preferable to use surfactant (surface-active agent) containing 8% or more of alcohol component in order to eliminate fishy odor from the tuna skin because the tuna skin has unique odor of fish. In addition, it is also preferable to add 2˜4% of sodium chloride (NaCl) to the surfactant so as to remove outer membrane since the tuna skin has viscid outer membrane on it.

### (2) Liming

This process is for eliminating hair (scales) of the tuna skin, and water-soluble protein and greasy matter between its outer layer and fibers, and for swelling the fiber structure of the tuna skin, by depositing the tuna skin into a solution containing a strong alkaline chemical such as calcium hydroxide.

It is necessary to add a strong alkaline chemical of two or three times higher in concentration than those used in the process of manufacturing general leather to remove hairs formed on the surface of raw hides, more specifically to add the amount corresponding to the ratio of 7˜8 with respect to the amount of 300 of water on the basis of mass when using Na₂S, so as to remove scales from the tuna skin.

With the process described above, scales are removed from the tuna skin and a unique odor of tuna is eliminated, by swelling the fiber structure thereon.

### (3) Deliming

This process is for neutralizing and removing the lime which has infiltrated into the tuna skin, with the use of deliming agent such as ammonium sulphate or ammonium chloride, and for returning the swollen state into the original state. With the process described above, the lime is removed from the fiber structure of the tuna skin having the scales removed, and it is possible to impart flexibility to the tuna skin, and to further eliminate the unique odor of the tuna at the same time.

### (4) Bating

This process is for loosening the fiber structure to improve the flexibility and elongation rate by hydrolyzing unnecessary protein layer (such as collagen) with a protein breakdown enzyme, and for acquiring leather of beautiful grain. It is preferable to use weak enzymes of 600˜700 of titer.

### (5) Pickling

This process is a pre-process for tanning, and is for depositing the tuna skin into an acid so as to give it an appropriate pH for long term preservation, so that it can be protected from mold and bacilli against deterioration.

It is preferable to use surfactants containing 8% or more of alcohol component in order to eliminate unique odor of fish.

In the process described above, the odor unique to fish is eliminated completely, while pH value of the tuna skin is being lowered by adding acid for tanning process.

### (6) Tanning

This process is for imparting thermal resistance, corrosion resistance, anti-perishability and flexibility to the tuna skin by transforming the collagen proteins of unstable structure into the property of mineral leather with the use of chrome. In the present invention, the fiber structure of the tuna skin is transformed into the property of leather by being subjected to a reaction with chrome.

### (7) Dyeing

This process is for imparting basic color and flexibility to the tuna skin, and its color and flexibility are adjusted to an appropriate level and produced depending upon the demand of the markets and their situations.

Synthetic oil is more appropriate for the fatliquoring agent than animal oil or vegetable oil, especially synthetic oil containing aromatics such as lemon flavor so as to conceal the odor unique to fish, and containing 10˜15% of organic solvents so as to increase the rate of infiltration is preferable.

In the case of present invention, it is necessary to adjust the degree of dyeing in order to exhibit a desired pattern as naturally as possible, depending upon whether the products to be manufactured are made by using scale pattern unique to tuna grain, or by using a moiré pattern unique to tuna skin that has been created through a splitting process as described later. If dyed heavily, the moiré pattern unique to the tuna skin will not be represented appropriately.

### (8) Drying

This process is for eliminating water contents completely from the leather which has been subjected to the processes described above, with the method of natural drying or machine drying such as kiln drying.

### (9) Splitting

In general, this process is for eliminating unnecessary tissue of raw hides or for physically adjusting the thickness of raw hides using machine. However, the splitting process that has been used only as a process for adjusting thickness in general leather products is applied as a process for creating unique novel patterns that have never been attempted, in order to make the characteristics of the fiber structure unique to tuna skins more distinctive in the present invention.

That is, if the dyeing chemicals are made to appropriately infiltrate into the tuna skin in the dyeing process described above and then the tuna skin is subjected to splitting process, it is possible to create various and delicate color tones along with unique patterns of tuna skin leather different from each other even though the same tuna skin is used.

### (10) Re-Dyeing

This process is optional. In the moiré pattern that has been created through the splitting process, the color given by the dyeing process will be shown as a background color and the other parts will be shown with light colors. By spraying dyes, the portions with light colors can be dyed as desired colors; the background color will be combined with the re-dyeing color to become a new color tone, thus making it possible to present a variety of moiré patterns of various colors.

### (11) Finishing

This process is for coating the tuna skin leather to cover up flaws and scars on the surface thereof, to make the tuna skin leather suitable for long term preservation, and to make desired products. In this process, chemical agents are applied to the surface of the tuna skin leather that has been subjected to the processes (1)˜(10) to make the scale patterns of the tuna skin and the tissue patterns unique to tuna be maintained as natural as possible, thereby making it possible to preserve current state and quality of the tuna skin leather for a long time.

### INDUSTRIAL APPLICABILITY

As described above, the tuna skin leather manufactured in accordance with the present invention is tougher and stronger comparing with conventional leather such as cowhide or sheepskin, thereby making it possible to apply to various sporting goods which require durability or other products.

Furthermore, since the tuna skin leather of the present invention is composed of lattice structure, it has superior venting property. Therefore, the tuna skin leather of the invention is suitable for materials for various footwear, gloves and so on.

1.-7. (canceled)

8. A tuna skin leather manufactured by a process comprising:
soaking a tuna skin in water, thereby restoring protein tissue of the original raw skin state and removing impurities and salt contents on the surface of the tuna skin to inhibit the activity of viruses;
liming the tuna skin after soaking the tuna skin in water by depositing the tuna skin in a solution of calcium hydroxide, thereby eliminating the scales of the tuna skin, a water-soluble protein and a greasy matter between the tuna skin's outer layer and fibers and swelling the fiber structure of the tuna skin;
deliming the tuna skin with a deliming agent, thereby neutralizing and removing the lime which has infiltrated into the tuna skin and returning the swollen state into the original state;
bating the tuna skin after deliming, by hydrolyzing the unnecessary protein layer of the tuna skin with a protease enzyme, thereby loosening the fiber structure to improve the flexibility and elongation rate and acquiring leather having beautiful grains;
pickling the tuna skin after bating, by depositing the tuna skin in an acid solution;
tanning the tuna skin after pickling, to transform the tuna skin into leather having the property of mineral leather, thereby imparting thermal resistance, corrosion resistance, anti-perishability and flexibility to the tuna skin;
dyeing the tuna skin after tanning, with one or more dyes and one or more fatliquoring agents, thereby imparting basic color tones and flexibility to the tuna skin;
drying the tuna skin after dyeing, thereby eliminating water contents from the tuna skin;
splitting the tuna skin after drying to create a moiré pattern unique to the tuna skin; and
finishing the tuna skin after splitting, thereby completing the tuna skin.

9. The tuna skin leather of claim 8, wherein the process further comprises re-dyeing the tuna skin leather after splitting.

10. A method of manufacturing a tuna skin leather comprising a soaking process, a liming process, a deliming process, a bating process, a pickling process, a tanning process, a dyeing process, a drying process, a splitting process to create a moiré pattern unique to the tuna skin and a finishing process.

11. The method of claim 10, further comprising a re-dyeing process after the splitting process.

12. The method of claim 10, wherein 2-4% of sodium chloride (NaCl) is further used to remove a viscid outer membrane of the tuna skin in the soaking process.

13. The method of claim 10, wherein a fatliquoring agent for the dyeing process comprises a flavoring agent to remove the odor unique to the tuna skin and 10-15% of an organic solvent to increase the rate of infiltration to the tuna skin.

14. The method of claim 13, wherein the flavoring agent contains lemon flavor.

15. The method of claim 10, wherein:
the soaking process comprises soaking the tuna skin in water;
the liming process comprises depositing the tuna skin in a solution of calcium hydroxide;
the deliming process comprises deliming the tuna skin with a deliming agent;
the bating process comprises bating the tuna skin by hydrolyzing unnecessary protein layer of the tuna skin with a protease enzyme;
the pickling process comprises depositing the tuna skin in an acid;
the tanning process comprises transforming the tuna skin into the property of mineral leather; and
the dyeing process comprises dyeing the tuna skin with one or more dyes and one or more fatliquoring agents.

16. A tuna skin leather manufactured by a process comprising a soaking process, a liming process, a deliming process, a bating process, a pickling process, a tanning process, a dyeing process, a drying process, and a splitting process to create a moiré pattern unique to the tuna skin.

17. The tuna skin leather of claim 16, wherein the process further comprises a finishing process after the splitting process.

18. The tuna skin leather of claim 17, wherein the process further comprises a re-dyeing process between the splitting process and the finishing process.
